(19) United States
(12) Patent Application Publication
(10) Pub. No.: US 2017/0330705 A1
(43) Pub. Date: Nov. 16, 2017

(54) ENCAPSULATED PUSH SWITCH

(71) Applicant: Wu-Hsu LIN, Taichung City (TW)

(72) Inventor: Wu-Hsu LIN, Taichung City (TW)

(21) Appl. No.: 15/152,844

(22) Filed: May 12, 2016

(51) Int. Cl. H01H 13/14; H01H 13/50; H01H 13/10

(52) U.S. Cl. CPC H01H 13/14; H01H 13/10; H01H 13/50

(57) ABSTRACT

A switch assembly has a switch unit and a separating cap. The switch unit has a pressing element. The separating cap is attached to the switch unit and encloses the pressing element. Accordingly, glue filled into an object in which the switch assembly is mounted can be kept from attaching to the pressing element and the operation accuracy of the switch unit can be improved.

### BACKGROUND OF THE INVENTION

### 1. Field of the Invention

The present invention relates to a switch assembly, and more particularly to a switch assembly for an electrical module.

### 2. Description of Related Art

With reference to FIG. 5, a conventional electrical module 91 applied to a thin object is connected with a switch assembly 92, and the switch assembly 92 has a pressing element 93. When the pressing element 93 is pressed, the electrical module 91 is turned on or off.

With reference to FIG. 6, to prevent the pressing element 93 from being pressed unintentionally, an annular separating wall 94 is arranged to enclose the pressing element 93. When the electrical module 91 and the switch assembly 92 are mounted in a body 95 of a thin object, such as a card, glue 96 filled into the body 95 can be separated from the pressing element 93 by the annular separating wall 94. Thus, the glue 96 can be kept from attaching to the pressing element 93, so the pressing element 93 is prevented from being badly influenced.

However, the conventional annular separating wall 94 is made of a double-sided tape and is cut to an annular form for enclosing the pressing element 93. The double-sided tape cannot provide a sufficient combining force to the body 95, so the glue 96 easily passes through a gap between the body 95 and the annular separating wall 94 and is attached to the pressing element 93 while the glue 96 is filled into the body 95. Therefore, operation accuracy of the switch assembly 92 is badly influenced by the glue 96.

To overcome the shortcomings, the present invention tends to provide a switch assembly to mitigate or obviate the aforementioned problems.

### SUMMARY OF THE INVENTION

The main objective of the invention is to provide a switch assembly that effectively prevents glue from attaching to a pressing element to improve the operation accuracy of the switch assembly.

The switch assembly has a switch unit and a separating cap. The switch unit has a pressing element. The separating cap is attached to the switch unit and encloses the pressing element.

Other objects, advantages and novel features of the invention will become more apparent from the following detailed description when taken in conjunction with the accompanying drawings.

### BRIEF DESCRIPTION OF THE DRAWINGS

FIG. 1 is a top view of a switch assembly in accordance with the present invention connected with an electrical module;

FIG. 2 is an enlarged exploded side view in partial section of the switch assembly in FIG. 1;

FIG. 3 is an enlarged side view in partial section of the switch assembly along the line 3-3 in FIG. 1;

FIG. 4 is an enlarged side view in partial section of the switch assembly in FIG. 1, shown mounted in a thin object;

FIG. 5 is a top view of a conventional switch assembly connected with an electrical module; and

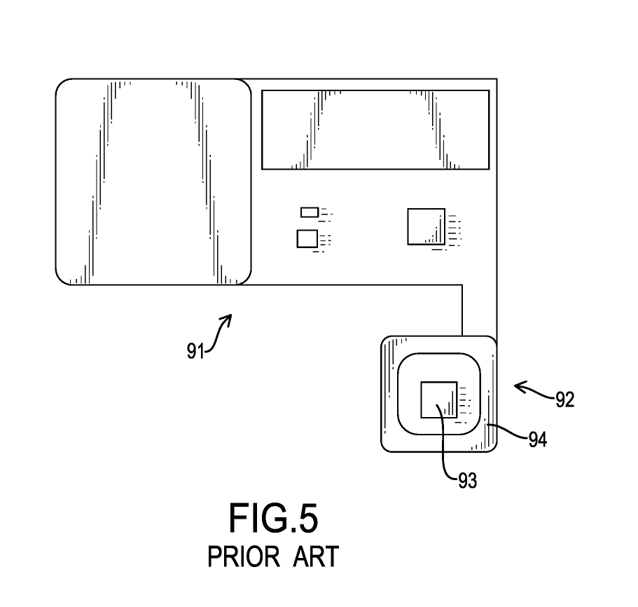

FIG. 6 is an enlarged side view in partial section of the switch assembly in FIG. 5, shown mounted in a thin object.

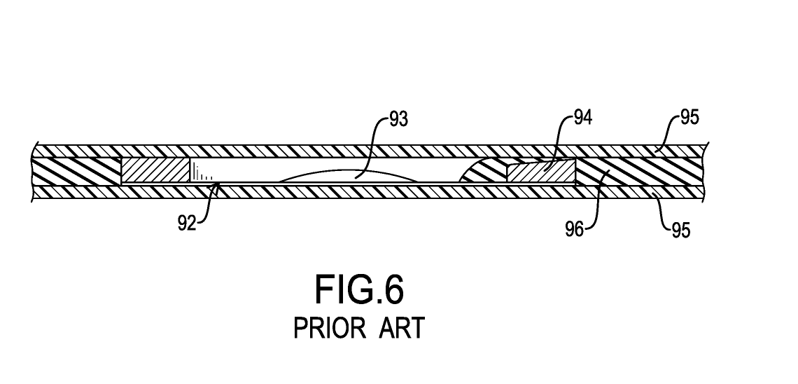

### DETAILED DESCRIPTION OF PREFERRED EMBODIMENT

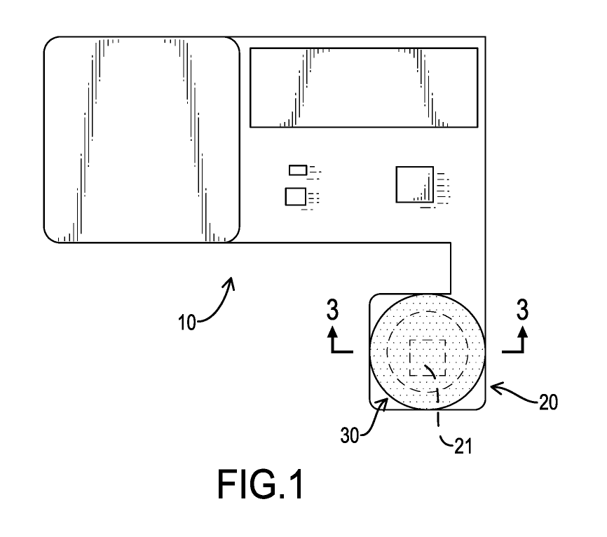

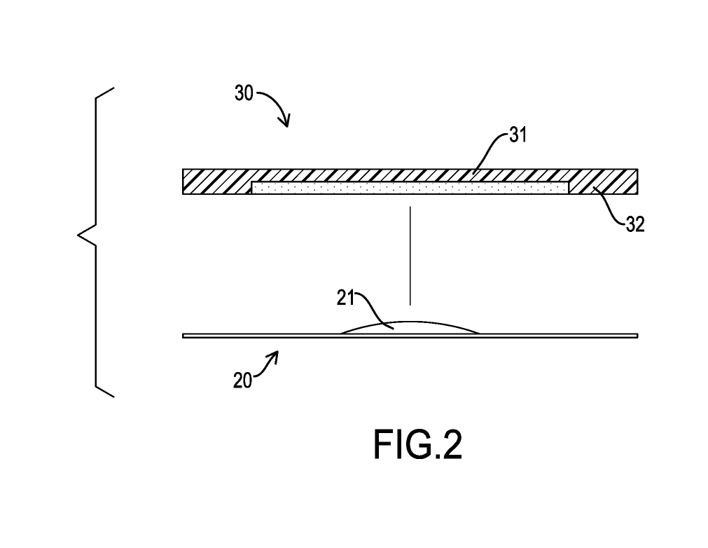

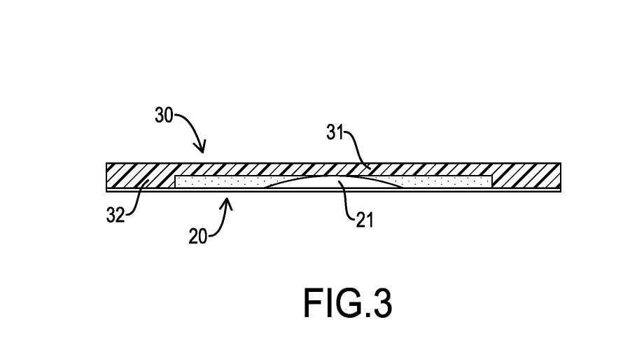

With reference to FIGS. 1 to 3, a switch assembly in accordance with the present invention is applied to connect with an electrical module 10 and comprises a switch unit 20 and a separating cap 30. The switch unit 20 is electrically connected with the electrical module 10 and has a pressing element 21 protruding from a center of the switch unit 20. The separating cap 30 is attached to the switch unit 20 and encloses the pressing element 21. The separating cap 30 comprises a cap board 31 and an annular flange 32. The cap board 31 may be circular and has a side facing the switch unit 20. The annular flange 32 is formed on and protrudes from the side of the cap board 31. The annular flange 32 has a side opposite the cap board 31 that is attached to the switch unit 20 by glue, thermal fusion, or Ultrasonic bonding to enclose the pressing element 21 inside the annular flange 32 in a sealed manner.

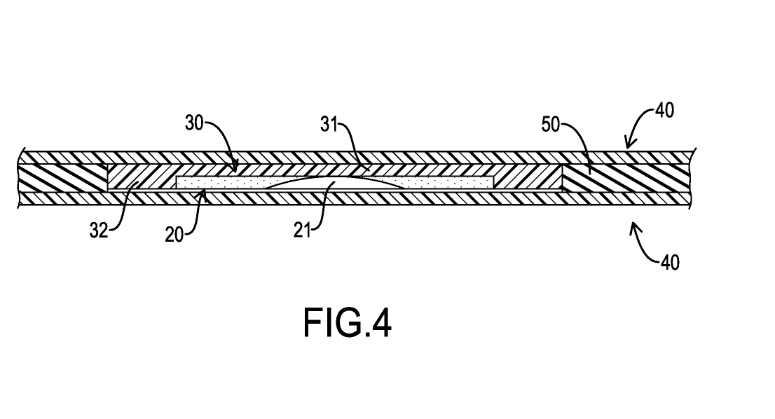

With reference to FIG. 4, when the switch unit 20 and the electrical module 10 are mounted in a thin object 40, such as a card, the glue filled into the object 40 can be separated from and kept from attaching to the pressing element 21 because the separating cap 30 is attached to the switch unit 20 to enclose the pressing element 21 in a sealed manner. Therefore, insufficient contact or malfunction of the pressing element 21 caused by the glue is prevented, and the operation accuracy of the switch unit 20 can be improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An encapsulated push switch comprising:
a switch unit having a pressing element mounted on a top of the switch unit; and
a separating cap attached to the switch unit and enclosing the pressing element, wherein the separating cap comprises
a cap board having a side facing the switch unit; and
an annular flange formed on and protruding from the side of the cap board and enclosing the pressing element and having a side opposite the cap board that is attached to the top of the switch unit on which the pressing element is mounted in a sealed manner.

2. (canceled)
